(19) United States
(12) Patent Application Publication
(10) Pub. No.: US 2005/0009598 A1
(43) Pub. Date: Jan. 13, 2005

(54) Gaming machine with coin control feature

(76) Inventors: James M. Rasmussen, Chicago, IL (US); Gary J. Strahinic, Mount Prospect, IL (US); Gregory J. Tastad, Kenosha, WI (US)

Correspondence Address: JENKENS & GILCHRIST, P.C., 225 WEST WASHINGTON, SUITE 2600, CHICAGO, IL, 60606, US

(21) Appl. No.: 10/616,464

(22) Filed: Jul. 9, 2003

(51) Int. Cl. A63F 13/00

(52) U.S. Cl. 463/25

(57) ABSTRACT

A gaming machine includes a coin input device for receiving coins that can be used to play a wagering game. The coin input device includes a coin control mechanism and a coin validation component downstream from the coin control mechanism. The coin control mechanism slows the velocity and properly spaces the coins to prevent jamming and to allow the coin validation component to accurately identify the currency value and authenticity of each coin.

### FIELD OF THE INVENTION

The present invention relates generally to gaming machines and, more specifically, to a gaming machine with a coin input device containing a mechanism for delivering coins to a validation component at a controlled velocity and interval. The term “coins” is intended to cover coins, chips, or tokens representing monetary value. The coins may be a medium of monetary exchange of a country, territory, gaming establishment, or other entity.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Players also appreciate the reliability of a gaming machine, as do the casino operators. Shrewd operators consequently strive to employ the most entertaining, exciting, and reliable machines available because such machines attract frequent play and hence increase profitability to the operator.

Other aspects of increasing game play involve the ability to place games at “ideal” locations during “ideal” playing times and the ability to make the player as comfortable as possible to increase the length of time they spend at the gaming machine. The design of the physical structure of the gaming machine usually takes into consideration a variety of factors including player comfort, physical input device requirements, audio device placement, and visual appearance, to name a few. During the design of a gaming machine, occasional compromises must be made that sometimes alter the “ideal” location of a device on the machine. If, for example, the device is a coin input device, alterations to its design may be required to satisfy the requirements of the components within the machine, the physical design, or within the device itself. Should the modification create a situation whereby the coin validation component, which is part of the coin input device, must be placed well below the coin slot (point of entry), the rate of travel of the coin through the entire device is increased presenting the potential for a variety of failures including jams and coin misreads. A mechanism that reduces the velocity of the coins through the coin validation component and properly spaces multiple coins traveling through the entire device would reduce the risk of failure due to jamming, assist the validation component in accurately identifying the coins, and reduce gaming machine design concerns which, in turn, would allow for greater design flexibility and, ultimately, a better gaming experience for the player.

### SUMMARY OF THE INVENTION

The present invention provides a coin control mechanism for a coin input device in a gaming machine. The coin control mechanism slows the velocity and properly spaces the coins to prevent jamming and to allow the coin validation component to accurately identify the currency value and authenticity of each coin.

### BRIEF DESCRIPTION OF THE DRAWINGS

The foregoing and other advantages of the invention will become apparent upon reading the following detailed description and upon reference to the drawings in which:

FIG. 1 is a pespective view of a gaming machine with a coin input device in accordance with the present invention;

FIG. 2 is a block diagram of a control system suitable for operating the gaming machine;

FIG. 3 is sectional view of a coin input device with a side-loading coin control mechanism taken generally along line 3-3 in FIG. 1;

FIGS. 4a through 4f are sectional views similar to FIG. 3 showing the movement of a single coin through the coin control mechanism;

FIGS. 5a through 5c are sectional views similar to FIG. 3 showing the movement of multiple coins through the coin control mechanism;

FIG. 6 is an exploded perspective view of a coin input device containing the coin control mechanism;

FIG. 7a is a sectional view similar to FIG. 3 showing a face-loading coin control mechanism;

FIG. 7b is a sectional, side view of the face loading mechanism depicted in FIG. 7a.

FIG. 7c is a sectional view showing an alternative to the face-loading coin control mechanism depicted in FIG. 7a;

FIG. 8a is a sectional view similar to FIG. 3 showing an alternative face-loading coin control mechanism;

FIG. 8b is a sectional, side view of the face loading mechanism depicted in FIG. 8a;

FIG. 8c is a perspective view of the face-loading coin control mechanism shown in FIGS. 8a and 8b.

FIG. 9a is a sectional view similar to FIG. 3 showing an alternative face-loading coin control mechanism;

FIG. 9b is a sectional, side view of the face loading mechanism depicted in FIG. 9a;

FIGS. 10a and 10b are sectional views similar to FIG. 3 showing alternative side-loading coin control mechanisms;

FIGS. 11a through 11c are sectional views similar to FIG. 3 showing examples of coin slots with velocity reducing features.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

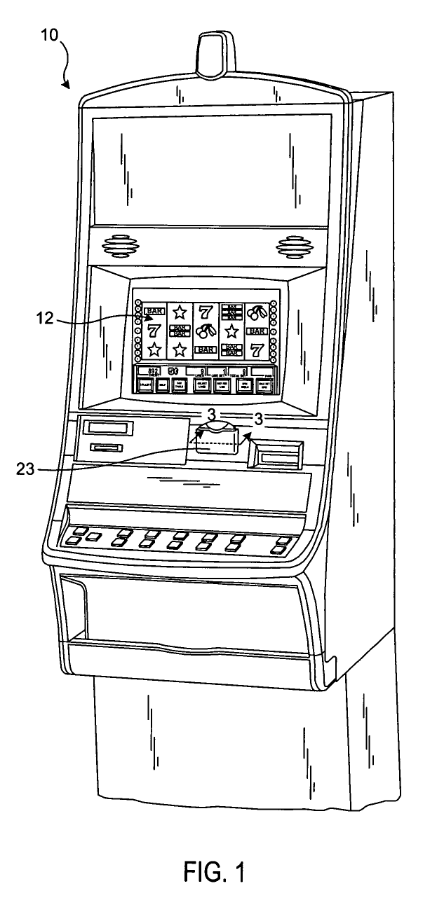

FIG. 1 depicts a gaming machine 10 operable to conduct a slot-based wagering game. In operation, the gaming machine receives a wager from a player to purchase a “play” of the game. In a “play” of the game, the gaming machine generates at least one random event and provides an award to the player for a winning outcome of the random event. The random event may be internally or remotely determined using a random number generator (RNG) or pooling schema. To portray the random event and outcome to the player, the gaming machine includes a primary display 12. If the wagering game is a reel slot game, for example, the primary display 12 includes a plurality of symbol-bearing reels that are rotated and stopped to place symbols on the reels in visual association with the pay line.

The primary display 12 may be implemented with a CRT, LCD, plasma, mechanical reels (in the case of a reel slot game), or other type of display known in the art. The primary display 12, especially if implemented in video, may be overlaid with a touch screen to facilitate interaction with the player. In the illustrated embodiment, the gaming machine 10 is an “upright” version in which the primary display 12 is oriented vertically relative to the player. Alternatively, the gaming machine may be a “slant-top” version in which the primary display 12 is slanted at about a thirty-degree angle toward the player of the gaming machine 10.

The gaming machine in FIG. 1 includes an example of a coin input device 23, which is one method of purchasing game play. Other devices used to purchase play on a gaming machine include bill acceptors and/or card readers. To purchase a play, the player places a coin in the coin slot of the coin input device 23 and releases it. Gravity forces the coin to drop through the coin input device 23 and, if validated, into a receptacle.

Coin validation components are manufactured by many companies including: IDX Inc., El Dorado, Ark., USA; Money Controls Ltd., Oldham, UK; and National Rejectors Inc., GmbH, Buxtehude, Germany. These devices use a variety of sensors to authenticate coins. Sensitivity to velocity and coin proximity varies from product to product but as will be recognized by those with ordinary skill in the art, coin validation devices are more accurate when the coin's rate of speed and interval are controlled.

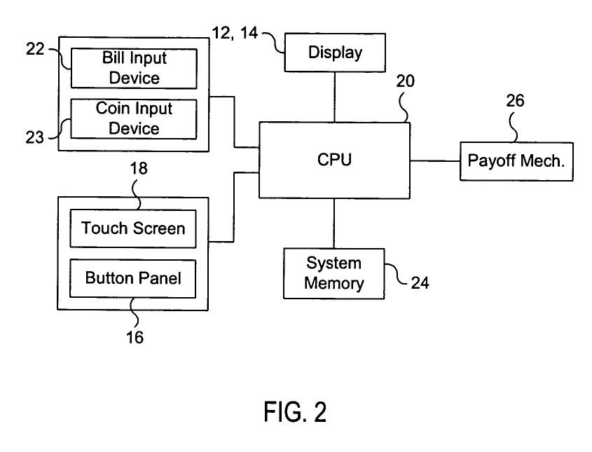

FIG. 2 is a block diagram of a control system suitable for operating the gaming machine. Bill input device 22 or coin input device 23 signals a central processing unit (CPU) 22 when a player has inserted money or played a number of credits. Using a button panel 16 the player may select any variables associated with the wagering game and place his/her wager to purchase a play of the game. In a play of the game, the CPU 20 generates at least one random event using a random number generator (RNG) or pooling schema and provides an award to the player for a winning outcome of the random event. The CPU 20 operates the display 12 to represent the random event(s) and outcome(s) in a visual form that can be understood by the player. In addition to the CPU 20, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure. A payoff mechanism 26 is operable in response to instructions from the CPU 20 to award a payoff to the player. The payoff may, for example, be in the form of a number of credits. The number of credits is determined by one or more math tables stored in the system memory 24.

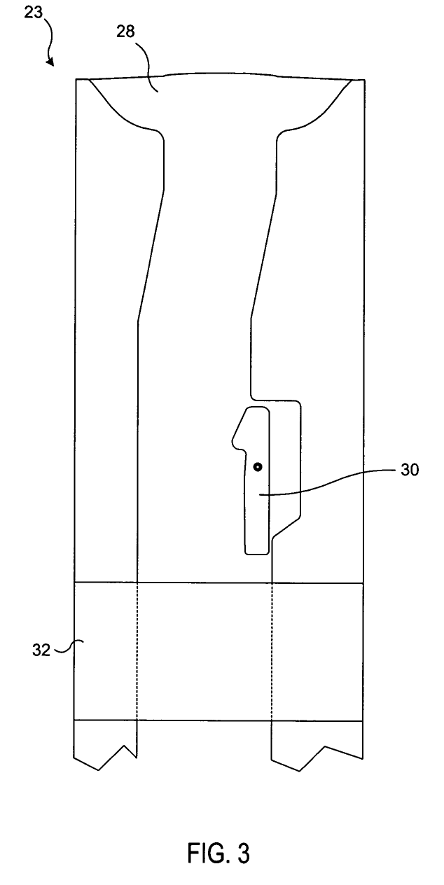

FIG. 3 is a cutaway view of the coin input device 23. In this embodiment, the device responsible for identifying and accepting coins, a coin validation component 32, is located well below the coin input device's entry slot 28 due to the design of the physical gaming machine. The distance between the entry slot 28 and coin validation component 32 is of a length that will cause the velocity of the coin traveling at the point of the coin validation component 32 to be of such a high rate as to potentially cause a failure in the ability of the coin validation component 32 to accurately scan the coin for authenticity. Additionally, if a number of coins are inserted into the coin input device 23 in a rapid fashion, the proximity of the coins are likely to be in such a manner as to cause an inaccurate evaluation by the coin validation component 32. Therefore, a “side-loading” coin control mechanism 30 is introduced to slow the velocity of the coin and properly space multiple coins at an interval that is satisfactory to the specifications of the coin validation component 32. “Side-loading” refers to the point at which the coin is impacted by the mechanism. Either the coin is slowed by impacting it on its edge or, alternatively, on its face (“face-loading”).

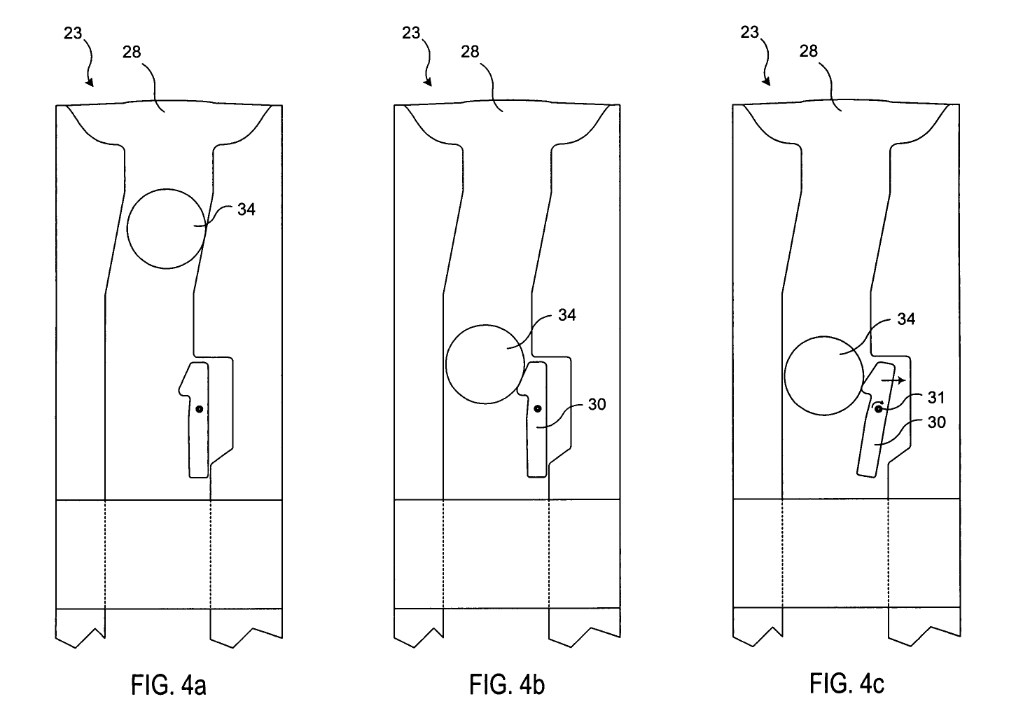

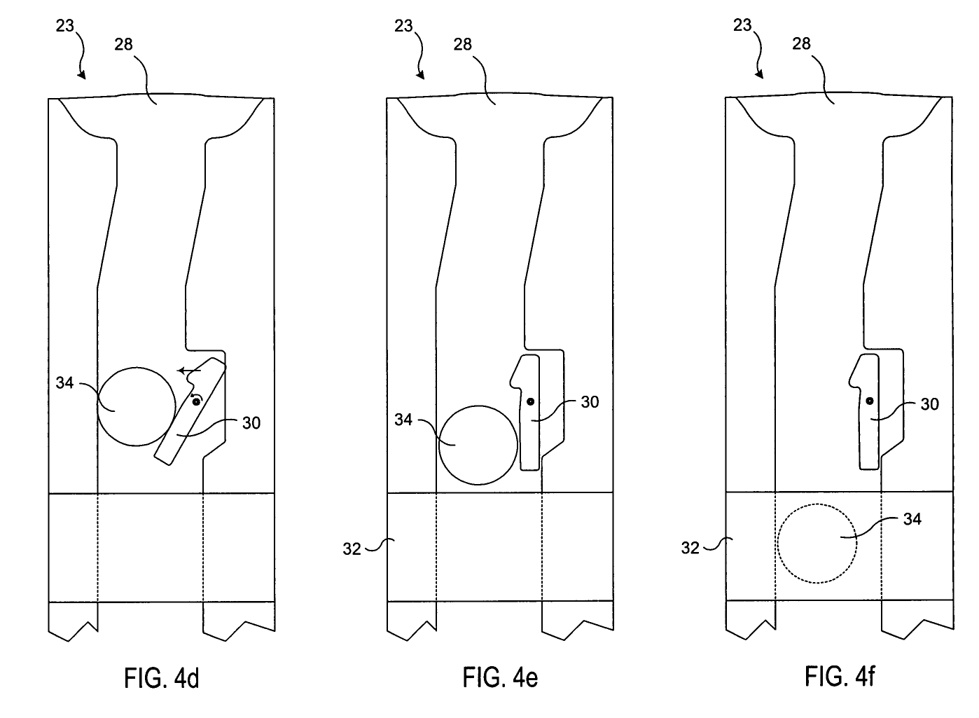

FIGS. 4a through 4f are a sequence of events that occur as a single coin 34 travels through the coin input device 23 and passes through a side-loading control mechanism 30. Referring to FIG. 4a, the coin 34 has been inserted into the entry slot 28 and is rapidly increasing speed due to the length of the coin path. FIG. 4b shows the coin 34 striking the coin control mechanism 30, rapidly reducing the rate of speed at which the coin 34 is traveling. FIG. 4c shows the coin 34 forcing the top portion of the coin control mechanism 30 away from the coin 34 by pivoting on pin 31. The force that is created by the weight and velocity of the coin 34 is the means by which the top portion of the coin control mechanism 30 is moved. As shown in FIG. 4d, the coin 34 has forced the top portion of the coin control mechanism 30 against the sidewall of the recess in the coin path, stopping the initial rotation of the coin control mechanism 30. The coin 34 drops further and strikes the bottom portion of the coin control mechanism 30, continuing the velocity control of the coin 34. The weight and speed of the coin force the bottom portion of the coin control mechanism 30 toward the sidewall of the coin path which, in turn, forces the top portion back toward its original position (FIG. 4e). FIG. 4f shows the coin traveling through the coin validation component 32. At this point, the coin 34 is moving at a much slower rate due to the interference provided by the coin control mechanism 30.

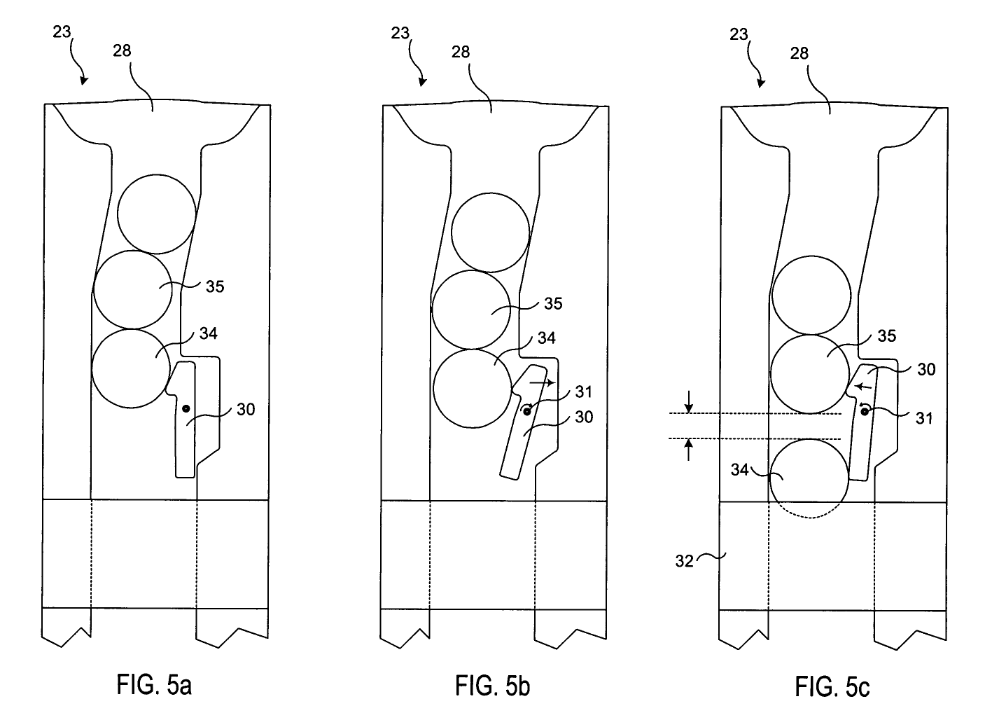

Another aspect of the invention is the ability of the coin control mechanism 30 to create space between coins moving through the coin validation component 32. By separating the coins traveling though the coin input device 23, the coin control mechanism 30 assists in preventing coin “jams” and provides the coin validation component 32 with a “clear view” of each coin. As depicted in FIGS. 5a through 5c, multiple coins can be in such close proximity as to “confuse” the coin validation device 32. FIG. 5a shows a series of three coins traveling through the coin path of the coin input device 23. The first coin 34 strikes the coin control mechanism 30, slowing the velocity of coin 34 and subsequent coin 35. FIG. 5b shows the first coin 34 forcing the top portion of coin control mechanism 30 toward the sidewall of the recess in the coin path. The coin control mechanism 30 pivots on pin 31. As the first coin 34 in FIG. 5c strikes the bottom portion of the coin control mechanism 30, the top portion is forced back toward its original position (shown in FIG. 5a). As the first coin 34 continues beyond the coin control mechanism 30, the second coin 35 is paused, thus creating a void or space between coin 34 and coin 35. Coin 34 continues through the coin validation component while coin 35 repeats the sequence past the coin control mechanism 30.

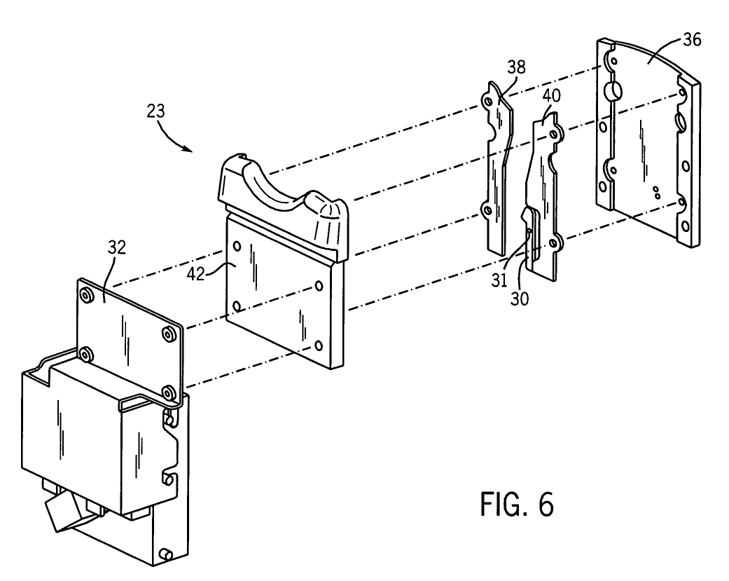

FIG. 6 shows an assembly drawing of the coin input device 23. The side plates of the coin slot 38, 40 are installed between the front plate 42 and the back plate 36. The coin control mechanism 30 is attached to the back plate 36 with the pivot pin 31 and is positioned in a recess in slot side plate 40. The coin validation component 32 is attached to the lower portion of the front plate 42.

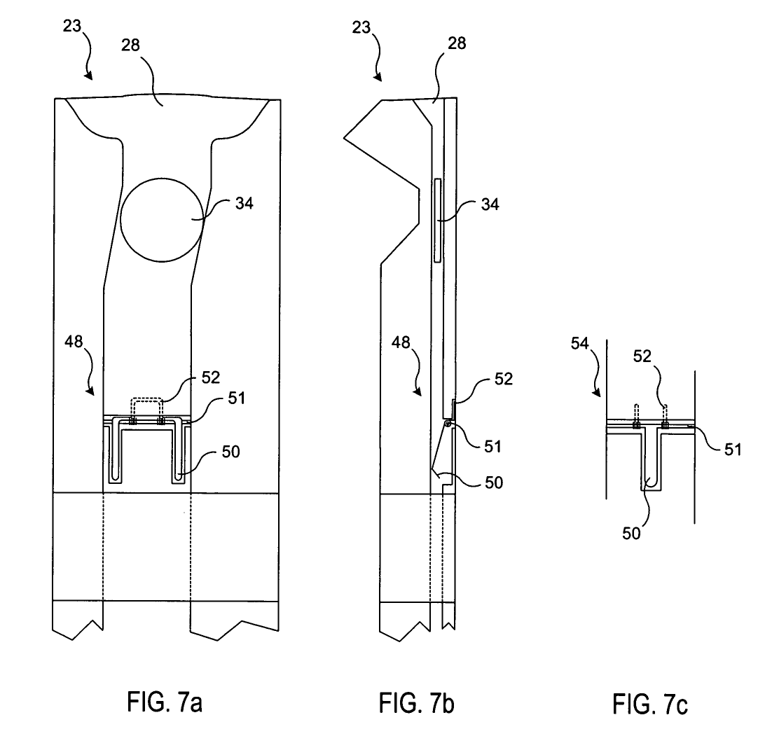

FIGS. 7a and 7b show an example of a face-loading coin control mechanism 48. In this embodiment, the coin 34 is slowed when it strikes “fingers” 50 of the coin control mechanism 48. The fingers 50 are wrapped around a pin 51 and continue into a slot 52. This provides the proper tension to the fingers 50. The coin control mechanism 48 could be made from spring steel or other flexible materials to provide the appropriate resistance to the coin as it passes. FIG. 7c shows a variant to this type of coin control mechanism. The single finger 50 is attached to a pin 51 and continues into a recess 52.

While the present invention has been described with reference to one or more particular embodiments, those skilled in the art will recognize that many changes may be made thereto without departing from the spirit and scope of the present invention.

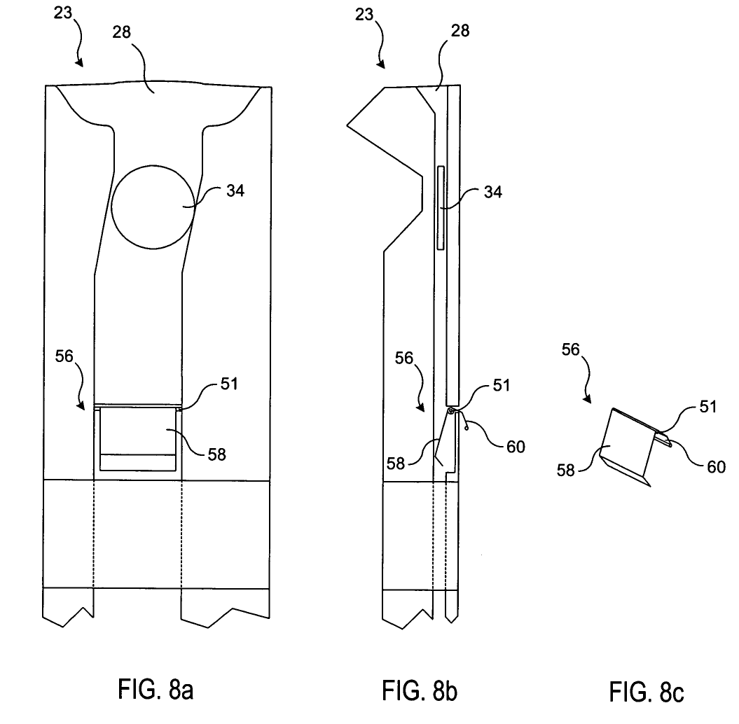

For example, a variation of a face-loading coin control mechanism 56 is shown in FIGS. 8a through 8c. In this example, a plate 58 is hung from a pin 51 and balanced using a counter-weight 60. The counter weight 60 provides the tension that ensures that the plate 58 is adequately positioned to slow the velocity of the coin 34.

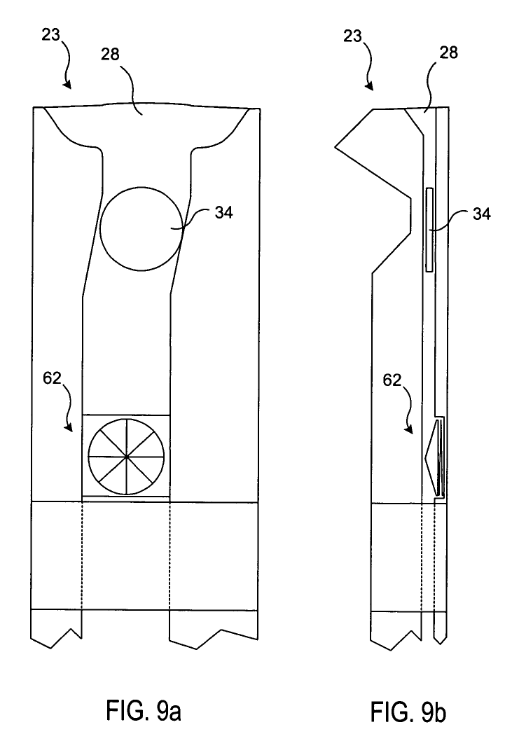

Another variant to a face-loading coin control mechanism 62 is shown in FIGS. 9a and 9b. This coin control mechanism 62 contains a cone shaped plate 64 attached to a conical compression spring 66. The conical compression spring 66 is placed against the wall of the slot, forcing the cone 64 to the opposite side.

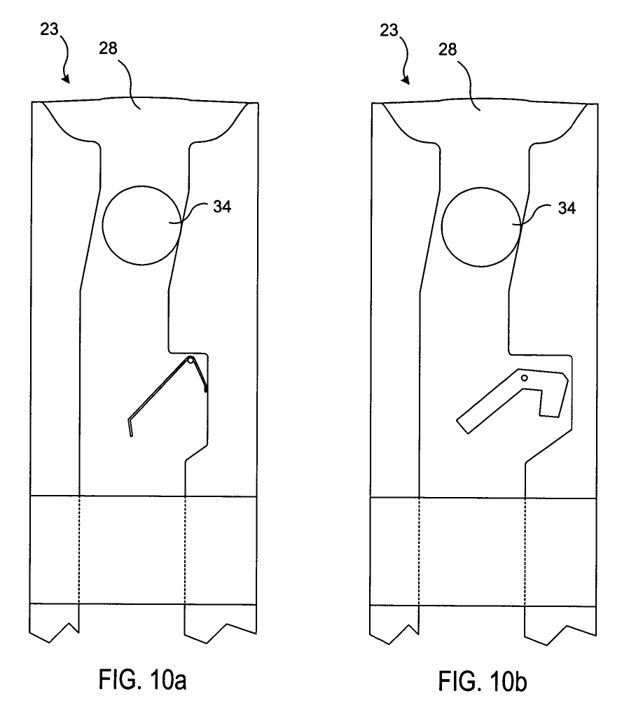

Alternative side-loading coin control mechanisms are shown in FIGS. 10a and 10b. FIG. 10a shows a spring steel mechanism bent over a pin with the opposite end placed against the side wall of the recess for tension. FIG. 10b shows a counter-balanced mechanism that moves in a lever motion.

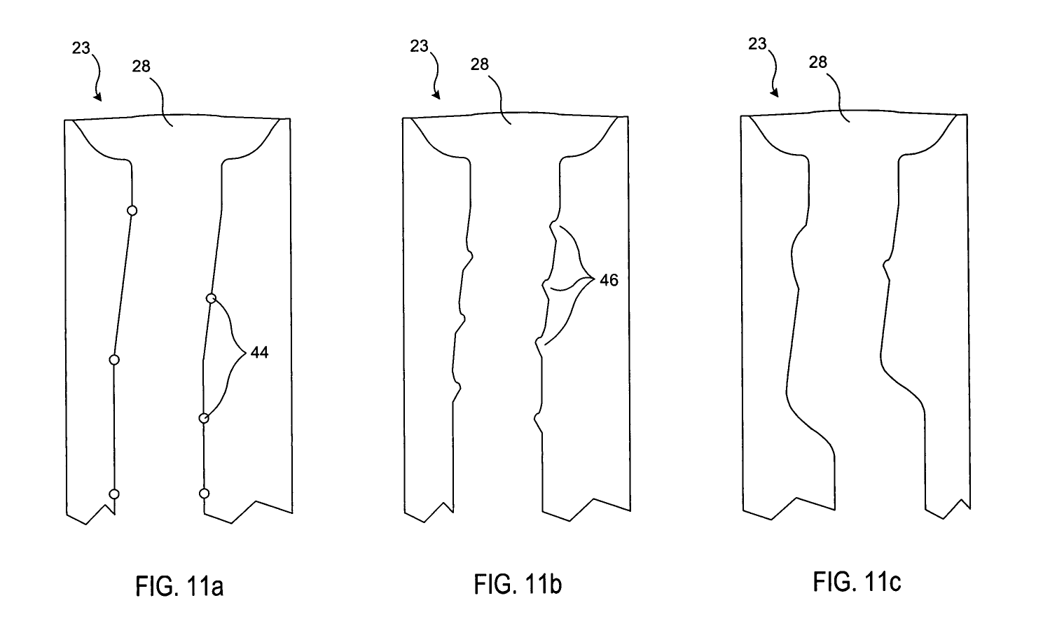

Alternatives to the mechanism approach are shown in FIGS. 11a through 11c. FIG. 11a shows the coin slot 28 with a number of posts or pins 44 to deflect and slow the coin traveling through the coin input device 23. FIG. 11b shows the coin slot 28 with a number of serrations 46 which also serve to deflect and slow coins moving through the coin input device 23. FIG. 11c shows a coin input device 23 containing a slot 28 configured with an abrupt change in the path that also slows the coins.

Each of these embodiments and obvious variations thereof is contemplated as falling within the spirit and scope of the claimed invention, which is set forth in the following claims.

1. A coin input device for accepting coins to play a wagering game on a gaming machine, comprising:
a coin path in which the accepted coins travel;
a validation unit along the coin path; and
a coin control feature along the coin path and upstream from the validation unit, the coin control feature being configured to slow a velocity of the coins and properly space the coins, thereby preventing jamming and allowing the validation unit to accurately identify and authenticate each coin.

2. The coin input device of claim 1, wherein the coin path is generally vertical such that the coins travel in the coin path by a force of gravity.

3. The coin input device of claim 1, wherein the coin control feature impacts the edges of the respective coins to slow the velocity of the coins.

4. The coin input device of claim 1, wherein the coin control feature impacts the faces of the respective coins to slow the velocity of the coins.

5. The coin input device of claim 1, wherein the coin control feature includes a pivoting member struck by each coin as the coins travel in the coin path.

6. The coin input device of claim 5, wherein the pivoting member includes a top portion and a bottom portion, the top portion being struck first by a coin to force the pivoting member to rotate in a first direction and then the bottom portion being struck next by the coin to force the pivoting member to rotate in a second direction opposite to the first direction.

7. The coin input device of claim 6, wherein the top portion is forced by the coin against a side wall of the coin input device to stop the pivoting member from rotating in the first direction.

8. The coin input device of claim 5, wherein the pivoting member is struck once by a coin to initially force the pivoting member to rotate in one direction and then struck again by the coin to force the pivoting member to rotate in an opposite direction.

9. The coin input device of claim 5, wherein the pivoting member impacts the edges of the respective coins to slow the velocity of the coins.

10. The coin input device of claim 5, wherein the pivoting member impacts the faces of the respective coins to slow the velocity of the coins.

11. The coin input device of claim 1, wherein the coin control feature includes a flexible cone shaped member connected to a conical compression spring.

12. The coin input device of claim 1, wherein the coin control feature includes a flexible spring member connected to, or bent over, a pin.

13. The coin input device of claim 1, wherein the coin control feature includes a number of posts, pins, or serrations along the coin path to deflect and slow the coins traveling in the coin path.

14. The coin input device of claim 1, wherein the coin control feature includes an abrupt change in a direction of the coin path.

15. A method of handling coins for playing a wagering game on a gaming machine, comprising:
accepting coins at a coin input device having a coin path;
transporting the accepted coins along the coin path;
controlling the coins with a coin control feature that slows a velocity of the coins and properly spaces the coins, the coin control feature being along the coin path; and
after controlling the coins, validating the coins.

16. The method of claim 15, wherein the coin path is generally vertical such that the coins travel in the coin path by a force of gravity.

17. The method of claim 15, wherein the controlling step includes impacting the edges of the respective coins to slow the velocity of the coins.

18. The method of claim 15, wherein the controlling step includes impacting the faces of the respective coins to slow the velocity of the coins.

19. The method of claim 15, wherein the controlling step includes impacting each coin with a pivoting member of the coin control feature as the coins travel in the coin path.

20. The method of claim 19, wherein the pivoting member includes a top portion and a bottom portion, the top portion being struck first by a coin to force the pivoting member to rotate in a first direction and then the bottom portion being struck next by the coin to force the pivoting member to rotate in a second direction opposite to the first direction.

21. The method of claim 20, wherein the top portion is forced by the coin against a side wall of the coin input device to stop the pivoting member from rotating in the first direction.

22. The method of claim 19, wherein the pivoting member is struck once by a coin to initially force the pivoting member to rotate in one direction and then struck again by the coin to force the pivoting member to rotate in an opposite direction.

23. The method of claim 19, wherein the pivoting member impacts the edges of the respective coins to slow the velocity of the coins.

24. The method of claim 19, wherein the pivoting member impacts the faces of the respective coins to slow the velocity of the coins.

25. The method of claim 15, wherein the coin control feature includes a flexible cone shaped member connected to a conical compression spring.

26. The method of claim 15, wherein the coin control feature includes a flexible spring member connected to, or bent over, a pin.

27. The method of claim 15, wherein the coin control feature includes a number of posts, pins, or serrations along the coin path to deflect and slow the coins traveling in the coin path.

28. The method of claim 15, wherein the coin control feature includes an abrupt change in a direction of the coin path.

29. A gaming machine comprising:
a processor for conducting a wagering game; and
a coin input device for accepting coins to play the wagering game, the coin input device including
a coin path in which the accepted coins travel;
a validation unit along the coin path; and
a coin control feature along the coin path and upstream from the validation unit, the coin control feature being configured to slow a velocity of the coins and properly space the coins, thereby preventing jamming and allowing the validation unit to accurately identify and authenticate each coin.

30. The gaming machine of claim 29, wherein the coin path is generally vertical such that the coins travel in the coin path by a force of gravity.

31. The gaming machine of claim 29, wherein the coin control feature impacts the edges of the respective coins to slow the velocity of the coins.

32. The gaming machine of claim 29, wherein the coin control feature impacts the faces of the respective coins to slow the velocity of the coins.

33. The gaming machine of claim 29, wherein the coin control feature includes a pivoting member struck by each coin as the coins travel in the coin path.

34. The gaming machine of claim 33, wherein the pivoting member includes a top portion and a bottom portion, the top portion being struck first by a coin to force the pivoting member to rotate in a first direction and then the bottom portion being struck next by the coin to force the pivoting member to rotate in a second direction opposite to the first direction.

35. The gaming machine of claim 34, wherein the top portion is forced by the coin against a side wall of the coin input device to stop the pivoting member from rotating in the first direction.

36. The gaming machine of claim 33, wherein the pivoting member is struck once by a coin to initially force the pivoting member to rotate in one direction and then struck again by the coin to force the pivoting member to rotate in an opposite direction.

37. The gaming machine of claim 29, wherein the coin control feature includes a number of posts, pins, or serrations along the coin path to deflect and slow the coins traveling in the coin path.

38. A coin input device for accepting coins to play a wagering game on a gaming machine, comprising:
a coin path in which the accepted coins travel;
means, along the coin path, for validating the coins; and
means, along the coin path and upstream from the validating means, for slowing a velocity of the coins and properly spacing the coins, thereby preventing jamming and allowing the validating means to accurately identify and authenticate each coin.
